(19) United States
(12) Patent Application Publication
(10) Pub. No.: US 2010/0216097 A1
(43) Pub. Date: Aug. 26, 2010

(54) REALISTIC MECHANIC SIMULATOR FOR SENSATIONS OF VEHICLES IN MOVEMENT

(76) Inventors: Claudio Romagnoli, Senigallia (IT); Maria Elena Paladini, Camerata Picena (IT); Pierino Romagnoli, Chiaravelle (IT)

Correspondence Address: CLAUDIO ROMAGNOLI, VIA SANZIO 69, SENIGALLIA, 60019, IT

(21) Appl. No.: 12/519,082

(22) PCT Filed: Dec. 28, 2007
(86) PCT No.: PCT/IB07/55340

§ 371 Date: Dec. 4, 2009

(30) Foreign Application Priority Data
Dec. 29, 2006 (IT) AN2006A000081

(51) Int. Cl. G09B 19/16; G09B 9/04

(52) U.S. Cl. 434/35; 434/62

(57) ABSTRACT

The invention consists of a prototype comprising three moving parts that can realistically simulate all the forces which subject a driver positioned in any moving vehicle. The first part has a circular motion with respect to its vertical axis of rotation and is supported by a fixed base, the second part, integral to the first part has a longitudinal movement (horizontal) perpendicular to the rotation axis of the first part. The third part, integral to the second part, acts as positioning for the user who is subject to the simulator's effects which has a circular motion with respect to its vertical axis of rotation that is parallel to the axis of rotation of the first part. The longitudinal movement of the second part in synergy with the first rotation of the first part and the instantaneous angular positioning of the third part, can continuously represent a development of any force such as acceleration, deceleration (braking) and lateral thrust present in any moving phase of a vehicle.

The invention simulates high acceleration in any dynamic condition, reproducing, thanks to the installation of small size motors, the sensations felt inside high powered vehicles (eg. F1 car).

The principle underlying the present invention is that at any moment, a person, who is inside a moving vehicle, being subjected to a resulting force, which, if it was artificially reproduced constantly, makes it imperceptible from a real driving situation.

Present mechanic emulators, despite the existing varieties and their differentiation in size and type of movement, have physical limits in creating realistic sensations of driving. They are not capable of reproducing a faithful simulation, such as direction and intensity of strength of the force which the driver is subjected to, but above all they do not reproduce the simulation of these forces continuously over time.

This invention is strongly innovative compared to those previous because it makes it possible to manufacture simulators which generate realistic physical sensations of intensity, direction, speed of transitional reply and persistence in time, so that a user cannot distinguish between reality and fiction. This total realism is achieved without the necessity of using high powered and expensive motors, thanks to the synergy of movement of the simulator components, so that the invention can be manufactured immediately.

### TECHNICAL FIELD

This invention is used for use in the amusement industry, especially in driving and/or flight simulators or any other vehicle placed in fair and/or an amusement arcade.

The invention may also be used for teaching and training for any type of driving school and for industrial use.

### BACKGROUND ART

Driving simulation systems, which usually do not have moving mechanical parts, are installed in amusement parks and amusement arcade. These simulation systems allow a user to feel the sensations of driving without exposure to the risks arising from real driving. These systems project the image of a vehicle in movement along a simulated road on a screen giving the driver the feeling of a real drive while he is acting only at a visual level.

These simulators have been further improved with moving mechanical parts, which can be defined as emulators, which move the pilot in the same directions as a real driver. These emulators improve the realism of the simulation, as well as visual sensations, and they also give physical sensations to the user. In fact one of the limitations of the simulators that use only software is the lack of physical sensation while driving, this does not give the idea of really being in a vehicle.

### DISCLOSURE OF INVENTION

### Technical Problem

Currently emulators, despite the existing varieties and their differentiation in size and type of movement, have physical limits in creating realistic sensation of driving. They are not able to reproduce a faithful simulation, in the direction and intensity of force, the stress undergone by driver, and above all do not give a simulation of these stresses continuously over a period of time. In fact, generally, the stresses are simulated using the weight of the pilot, tilting the emulator in a certain direction, or using large linear motors that move the cabin with a certain degree of freedom in that small space, producing sensations limited in intensity and in time exposure.

### Technical Solution

The proposed solution is a Simulator comprising three moving parts which are joined and work together, and a part which acts as a fixed base. The first part has a circular motion on its vertical axis in respect to a fixed base, the second part, integral to the first, has a longitudinal movement perpendicular to the rotation axis of the first part.

The third part, integral to the second part, in which the user is positioned and is the subject of the simulator's effects, has a circular motion with respect to its axis (parallel to the first part).

### ADVANTAGEOUS EFFECTS

This invention is very innovative compared to previous models because it can make a simulator that generates physical sensations of realistic intensity, direction, speed of variation and durability, so that the user cannot distinguish between fact and fiction. This total realism is achieved without the need to use motors which are very powerful and expensive, thanks to the synergy of movement of the components constituting the simulator, so the invention can be manufactured immediately.

The radial movement of the second part in synergy to the rotation of the first part and the instantaneous angular positioning of the third part, can represent continuously, any trend of acceleration, deceleration (braking) and lateral force which presents itself in any driving situation. The simulator allows a simulation of high acceleration in any dynamic condition reproducing, with relatively small engines, the feeling of being inside high powered vehicles (eg. F1 car). The same concepts expressed previously are applied to flight simulation, considering that to cover all dynamic situations in the case of flight it is necessary to increase the ‘degrees of freedom’ of the third part.

### DESCRIPTION OF DRAWINGS

FIG. 1 Overall view of the simulator where the main constituent parts of the invention are indicated: the base, the first part, the second part and the third part, where it is possible to see the main axes of movement. The positioning of the user enjoying the effects of simulation are also visible.

FIG. 2 General overview of the simulator where the basic physical parameters which characterize the dynamics of the prototype are highlighted.

FIG. 3 Overview of the simulator where it is possible to identify the main mechanical and electromechanical components.

FIG. 4 Overview of the simulator where it is useful to highlight the three ‘degrees of freedom’ of movement consisting of two axes of rotation and one of horizontal movement.

FIG. 5 Partial view from above of the simulator (it is possible to see the first and third parts) where the angle positioning of the third part is represented.

FIG. 6 Partial view from above of the simulator which represents the angle between the longitudinal axis of the third part and the resulting force generated by the simulator.

FIG. 7a View from above of the third part of the simulator where it is possible to see the user being subjected to lateral thrust on a simulated curve.

FIG. 7b View from above of the third part of the simulator where it is possible to see the user being subjected to the simulated force of braking.

FIG. 7c View from above of the third part of the simulator where it is possible to see the user being subjected to simulated acceleration.

FIG. 8 View from above of the third part where it is possible to see the user being subjected to the centrifugal force generated by the simulator.

FIG. 9 View from above of the simulator where two positions of the third part (pos.1 and pos.2) are represented which are mirrored in respect to the rotation axis of the first part

FIG. 10a View from above of the third part where it the undesired force (parasitic) generated from acceleration of the second part compared to the first part is represented.

FIG. 10b View from above of the third part where the undesired force (parasitic) generated from an angle of the first part is represented.

FIG. 10c View from above of the third part where the undesired force (parasitic) generated from an angle of the first part is represented.

FIG. 11a Simulator seen from above where different positions of the third part with the forces showing the user in such positions are represented. The figure shows how it is possible to simulate a dynamic transition from the state of constant speed or stationary, to the state of acceleration.

FIG. 11b Simulator seen from above where different positions of the third part with the forces showing the user in such positions are represented. The figure shows how it is possible to simulate a dynamic transition from the state of acceleration to the states of constant speed or stationary.

FIG. 12a Simulator seen from above where different positions are represented of the third part with the forces which show the user in such positions. This figure shows how it is possible to simulate dynamically the transition from the state of constant speed, to that of braking (deceleration).

FIG. 12b Simulator seen from above where different positions of the third part with the forces showing the user in such positions are represented. This figure shows how it is possible to dynamically simulate the transition from the state of braking to the states of constant speed or stationary.

FIG. 13a Simulator seen from above where different positions of the third part with the forces showing the user in such positions are represented. This figure shows how it is possible to dynamically simulate the transition from the state of braking, to lateral thrust (curve);

FIG. 13b Simulator seen from above where different positions of the third part with the forces showing the user in such positions are represented. This figure shows how it is possible to dynamically simulate the transition from the state of lateral thrust to the state of acceleration.

FIG. 14a This chart indicates the trend of acceleration generated by the dynamics of the Simulator.

FIG. 14b This chart indicates the trend of deceleration generated by the dynamics of the Simulator.

### KEY FIGURE SYMBOLS AND REFERENCES

0 fixed base of the simulator
1 first moving part of the simulator
2 second moving part of the simulator
3 third moving part of the simulator
4 hearings of the second part
5 axis of rotation of the first part
6 axis of rotation of the third part
7 positive direction of rotation of the first part
8 positive direction of rotation of the third part
9 axis translation of the second part
10 motor of the first part
11 fixed part of the stator of the linear motor of the second part
12 moving part of the linear motor of the second part
13 shock absorbers to compensate centrifugal forces which show the second and third parts.
14 motor and adapter of the third part
15 referring axis of the third part.
16 user shown with simulated effects generated by s the simulator.
17 positive direction of speed and tangential acceleration of the first part.
18 positive direction of linear velocity and acceleration of the second part.
19 positive direction of angular velocity vector of the first part.
20 positive direction of angular velocity vector of the third part.
21 slide rail of the second part on the first part.
A_{c}
Centrifugal acceleration produced by the simulator on the barycentre of the user R distance between the barycentre of the user and the axis of rotation of the first part.
ω₁
Angular speed of the first part.
mₘₛ
Mass of the user.
α
Positioning Angle of the third part in respect to the first part (the angle between the referring axis of the third part and the longitudinal movement axis of the second part).
β
[symbol] angle between the referring axis of the third part and the vector of the resulting force produced by the simulator on the barycentre of the user.
Fᵣᵢₛ
resulting force produced by the simulator on the barycentre of the user.
O_{S}
barycentre of the user.
O₁
barycentre of the first part.
O₃
barycentre of the third part.
v₂
Speed of the second part.
F_{C}
Centrifugal force acting on the user, produced by the rotation of the first part.
Fₜ
Tangential force acting on the user produced by the angular acceleration of the first part.
Fᵣ
Radial force acting on the user produced by the second part along the diameter of the first part.
F_{cor}

Coriolis force acting on the user produced by radial movement of the second part on the first part in rotation
a₁
Tangential acceleration of the first part.
a₂
Acceleration of the second part.
v₁
Tangential speed of the first part.
ω₃
Angular velocity of the third part.
g
Acceleration of gravity
t
Time
tₛ
Rise time (parameter characterizing the evolution of the transitional reply)
Pos-1 indicates one position of the third part compared to the first part.
Pos-2 shows one position of the third part compared to the first part.
Pos-3 indicates one position of the third part compared to the first part.
Pos-4 indicates one position of the third part compared to the first part.
Pos-5 indicates one position of the third part compared to the first part.

### DESCRIPTION OF INVENTION

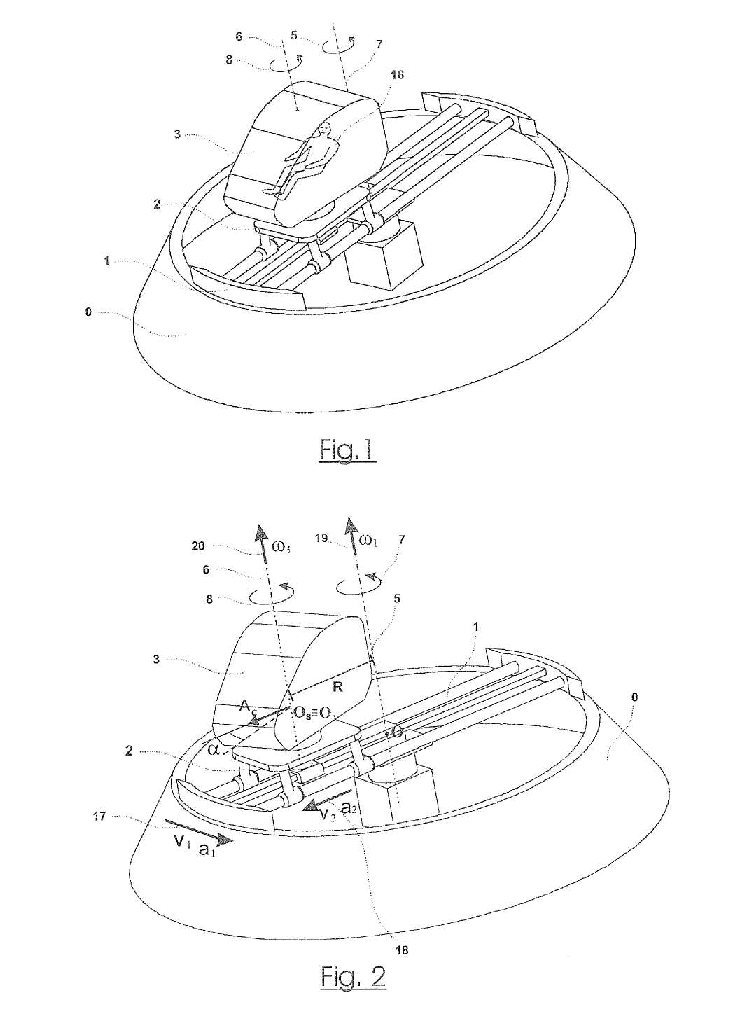

The Simulator comprises three mobile parts which work together, and which have different characteristics depending on the function they are assigned (allocate). The invention also comprises by a fixed part which acts as base of the entire prototype (FIG. 1).

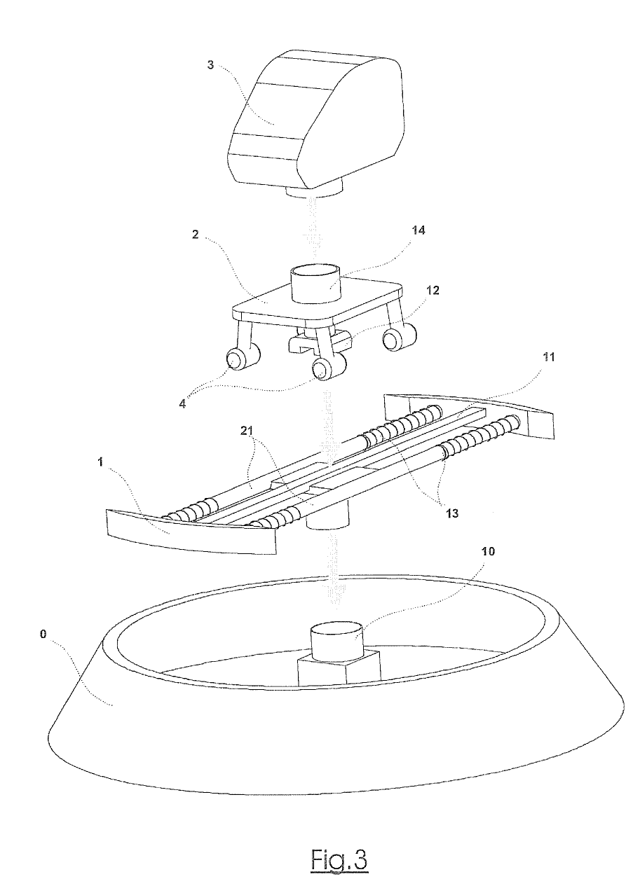

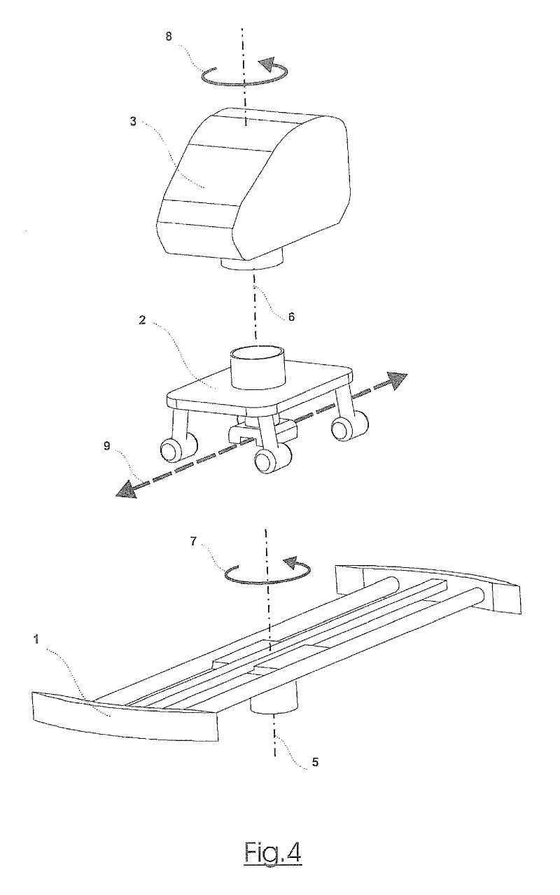

The base or Part 0 (FIG. 3), is the component which does not characterize so much the Simulator, because it has the unique purpose of maintaining fixed the moving structure to the ground. This element consists essentially of a concave structure with a cylindrical shape within which is fixed the motor that moves part 1.
Part 1 comprises three longitudinal rods (bars) with the extremes hinged at two cross bars shaped like a half-moon (FIG. 2), as well as a central part which is hinged at the rotation motor 10 of part 1 allowing the rotation of part 1 on a cylindrical base. The two external cross bars 21 act as support and slide for part 2, while Central bar 11 represents a portion of the stator of the linear motor which gives propulsion to part 2 (FIG. 1). To the longitudinal side bars are set the bearings 22 which allow the sliding of part 2 on part 1 in longitudinal movement (axis 9 in FIG. 4).

The shock absorbers 13 are placed to the ends of the longitudinal rods of part 1 that reduce the centrifugal force generated by the rotation of part 1 on parts 2 and 3, which must be compensated by the motor 11/12. These components are essential to reduce the power that should be supported by the linear motor 11/12 in situations of working with high force of the Simulator (a generation of strong simulation forces) in the presence of high rotations of part 1 and high values of distance R. The shock absorbers 13 make the application of linear motors possible with limited power allowing a limitation of the costs of production of the Simulator.

Part 2 consists of a base that is linked to part 1 through vertical and/or horizontal bars (FIG. 3). It is hinged to part 1 through bearings 22 positioned at the ends of vertical bars. In the central zone of the base there is an opening in which is placed: at the top, motor 14 of part 3, in the lower part the moving component 12 of the linear motor that moves part 2.

Part 3, the last component (FIG. 1), consists of a cabin where the user 16 (a person or an object it is positioned, who benefits from the effects of the final simulation produced by the Simulator. Part 3 consists of a rigid tubular frame that serves as a support of the structure of part 3 and as a clamp for the covering panels. This rigid tubular frame is fixed to a base on which the shaft of the motor 14 of part 3 (FIG. 3) is fixed.

The type of movement of the three rigid parts, part 1, part 2 and part 3 (FIG. 4), is what characterizes the functioning of the Simulator. In fact, thanks to the combined three movements, we get the final result that generates a realistic simulation, without time restrictions, of high acceleration in any direction and with short transition time (short rise times

tₛ

see FIG. 14a)

Part 1 has a circular motion 5 with constant direction of rotation (FIG. 2 and FIG. 4); the direction of rotation considered as the positive one 7 is anti-clockwise.

The function of part 1 is to generate a centrifugal acceleration

### A_{c}

on the user 16 positioned in part 3 (FIG. 2). This centrifugal acceleration depends on the distance R of the barycentre

### O_{S}

of the user 16, from the rotation axis 5 of part 1 (shown in FIG. 2. for simplicity the specific case was taken in which the user barycentre

### O_{S}

is coincident with the Barycentre

### O₃

of the part 3), and it depends on the angular speed

ω₁

of part 1 following the law

A_{c}=R·ω₁².

The centrifugal force

F_{c}=mₛ·A_{c}

generated by the movement of part 1 and the position of part 2 on the user 16 with mass
mₛ
(positioned inside part 3 FIG. 1), is the force which has to be adjusted. In fact it is modulating this force by movements of part 2 and 3, from which you can get an effective simulation with seamless continuity so reproducing desired results faithfully. Each element of the Simulator is fundamental and characteristic for its correct functioning.

Part 2 which has a longitudinal movement (FIG. 4) and which is the only one which does not have a circular motion, is the key element to decreasing the transitional times (rise times

tₛ

FIG. 14a) in generating acceleration by limiting the inertia moment of the prototype. The movement of part 2 can generate, as an alternative, high accelerations on the user. Its function is to vary the distance R (FIG. 2) of part 3 in respect to the rotation axis 7. It is also interesting to point out that, with the same angular speed

ω₁

[symbol] part 2 if it is positioned in opposition to the centre of part 1 (see Pos-1 and Pos-2 FIG. 9), will create a force in the opposite direction. So Part 2 in addition to varying the radius R is also able to reverse the force applied to the user. Part 2 is the key to making the simulator effectively manufacturable because it avoids the use of very powerful motors to reach its goal.

According to the formula

A_{c}=R·ω₁²,

the absolute value of the acceleration generated from part 1 can be modified either by varying the angular speed

ω₁

of part 1 [9] (thanks to the motor 10), or with the radial movement R of part 2 in respect of part 1 (thanks to the linear motor 12).

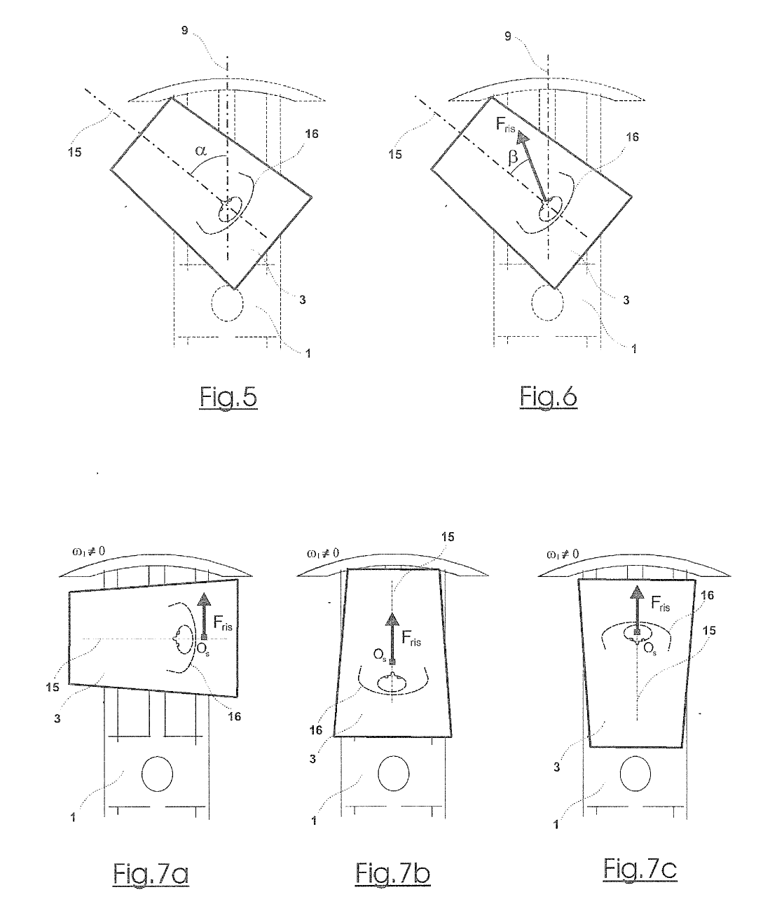

As for the final component (part 3), a conventional direction 15, called the axis of the part 3 (FIG. 5), has been taken as reference and has been indicated an angle positioning

α

of part 3, which represents the angle among axis 9 (longitudinal axis of the part 2, FIG. 5 and FIG. 4) and the axis 15 of part 3 (FIG. 5).

The purpose of part 3, which has a rotational movement 8 in respect to its axis of rotation 6 (FIG. 2 and FIG. 4), is to appropriately adjust the angle

β
(see FIG. 6 and [94]) on the power generated by the Simulator, modifying the positioning angle
α [symbol]
part 3 in respect to part 2 (FIG. 2 and FIG. 5).

The angle

β

[symbol] (FIG. 6) is the angle between the resulting force

### Fᵣᵢₛ

[symbol] generated by the Simulator on user 16, and the axis 15 of part 3. This angle has a value different from zero and thus implies the presence of a component of lateral force on the user that is equivalent to a cornering force. The absolute value and the direction of resulting force

### Fᵣᵢₛ

[symbol] [symbol] [symbol] [symbol] are variables, and depend on the dynamic conditions of the Simulator generated by the movement of parts 1 and 2 (FIG. 6).

The overall action of the Simulator derives from the combination of movements of parts 1, 2 and 3 and the effect of the simulation is felt only by the user 16 integral to the final part (in the figures given, except FIG. 1, user 16 is represented by one person viewed from above).

Inside part 3, as was partially anticipated in [14], a conventional origin and direction 15 (FIG. 7) are represented. The origin is taken at the barycentre

### O_{S}

[symbol] of the user, while the direction of reference 15 is the axis of part 3, that is the line which cuts part 3 lengthwise (FIGS. 5, 6). For an easier description,

### O_{S}

[symbol] which is applied to the resulting force Fᵣᵢₛ

is represented slightly shifted compared to its real position.

The working of the Simulator allows you to simulate the effect of variable force, both in direction and in absolute value, on the user 16, positioned within part 3, according to a certain desired progress in the time, for high values of force and very short rise times

tₛ

The main purpose of the prototype is faithfully to reproduce the forces which is subject a driver (or passenger) 16 while driving a vehicle.

As already mentioned, thanks to the particular shape of the prototype, it is possible to reproduce seamless continuity, and without interruption, all the physical sensations that the driver 16 is subjected while driving a vehicle, caused by: ACCELERATION FORCE; DECELERATION FORCE (BRAKING); LATERAL FORCE (CENTRIFUGAL FORCE) ON A BEND, or various combinations of these.

Sensation felt by a driver 16 in a vehicle depend on the third law of dynamics which explains that “at any action return an equal and opposite reaction”, see FIG. 7-a, FIG. 7-b and FIG. 7-c representing respectively LATERAL FORCE ON A BEND, BRAKING and ACCELERATION FORCE on the user 16.

At any time the driver 16 is subject to a resulting force

### Fᵣᵢₛ

(with the exception of the states constant speed or vehicle stopped in which the force is zero and sensations created by ascents, descents and bumpy terrain) which is the combination of forces identified in paragraph [99]. That force

### Fᵣᵢₛ

is variable depending on the direction which the force has on the user 16 and is defined as acceleration, braking or cornering lateral thrust in cornering.

The principle underlying working of the Simulator is to reproduce at any time the resulting force

### Fᵣᵢₛ

which would be present while driving a real vehicle.

In this document “forces” are defined as those forces applied to the user 16, and refer to the effect of acceleration on the user's mass

mₛ

(which is constant). So it is irrelevant to talk about acceleration or forces because they are equivalent, unless it is the factor of proportionality

mₛ.

The Simulator is able to reproduce the forces inside the driver's cabin of a vehicle.

The forces ACCELERATION BRAKING and LATERAL FORCE which subjects the user 16 are for the Simulator, the phases of its essential functioning.

When we talk of phases of functioning for the Simulator (acceleration, braking, and lateral force) we mean in fact transitional dynamic states for the driver 16 while driving a real vehicle. This is because the working of Simulator is different from the working of a vehicle in movement. During the reality of driving, in fact, the acceleration, braking and cornering thrust (except on roundabouts) can be maintained for a limited time, as opposed to what can be achieved with the simulator.

The reproduction by the Simulator of ACCELERATION is represented in FIG. 7c. The angle

β

[symbol] amounts 180° (FIGS. 6 and 7).

The reproduction by the Simulator of BRAKING is represented in FIG. 7b. The angle

β

[symbol] [symbol] is 0 (FIGS. 6 and 7).

The reproduction by the Simulator of LATERAL FORCE ON A BEND is represented in FIG. 7a. The angle [symbol] [symbol] is different both from 0 and 180° (see also [94] and FIG. 6). If the value of

β

[symbol] is between 0° and 90° (extremes excluded) we have simultaneous BRAKING and LATERAL THURST, while if

β

[symbol] is between 90° and 180° (extremes excluded) we have simultaneous ACCELERATION AND LATERAL THURST. In a perfectly circular curve this angle is +−90°. By varying the angle

β

[symbol] through the rotation of part 3 it is possible to generate all possible combinations of cornering forces, lateral thrust with braking or lateral thrust during the acceleration.

ACCELERATION (

β

=)180° and BRAKING (

β

=)0° are complementary effects of the same force applied in opposite directions.

There are two other states in the functioning of the simulator than those indicated in [24], which are entirely equivalent at the functional level, and which are characterized by the absence of forces: A VEHICLE WITH CONSTANT SPEED (perfectly inertial system) and A STATIONARY VEHICLE. Both these states are obtained with

ω₁≈

0 and

v₂

=0.

Once verified (FIG. 7) that the simulator is able to reproduce the forces ACCELERATION, BRAKING and LATERAL THUST, to have a faithful and continued simulation of driving reality, it is necessary to examine how we can move from one state to another reproducing the dynamic conditions existing in a real vehicle. When driving a real vehicle, in fact, the driver 16 is subject to forces that, depending on the route and on the characteristics of the vehicle, vary more or less rapidly during the time, passing from acceleration to constant speed, from braking to cornering and to acceleration, etc. The Simulator must be able to simulate dynamically the transition from one state to another (see also [105])

The representation of a dynamic functioning requires a particular analysis because, considering how the Simulator is structured, during the transition from one state to another, additional forces will be generated, known as ‘parasitic forces’, which must be compensated by the Simulator.

The ‘parasitic forces’ that the Simulator generates during its dynamic working, are mainly produced by the movements of parts 1 and 2 (the centrifugal effects can be ignored produced by part 3). The forces generated are, CENTRIFUGAL FORCE

### F_{c}

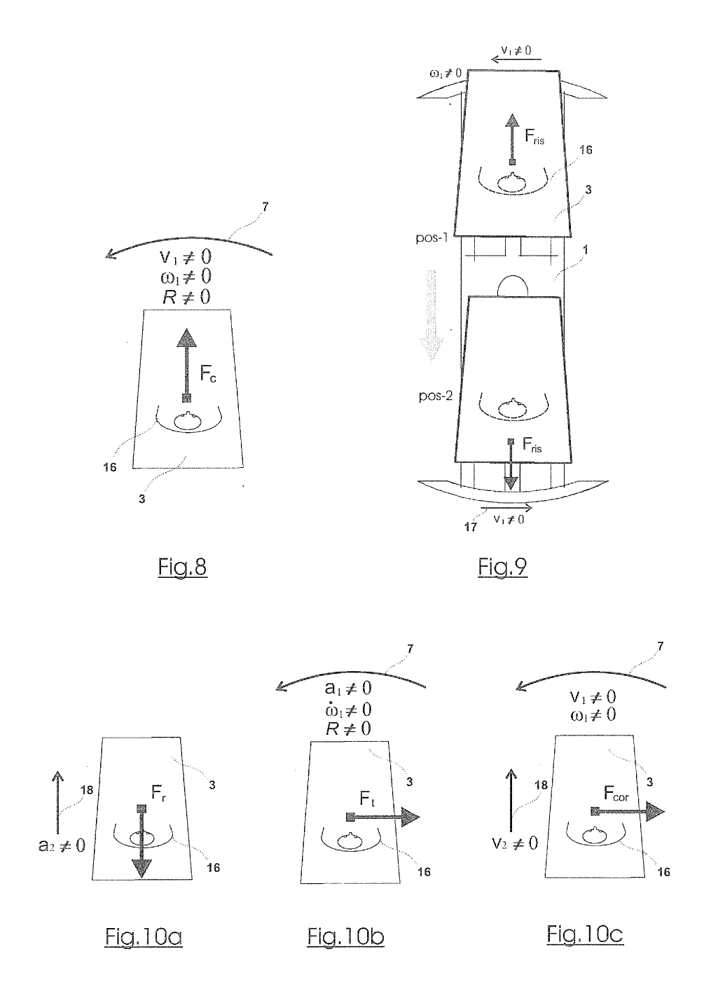

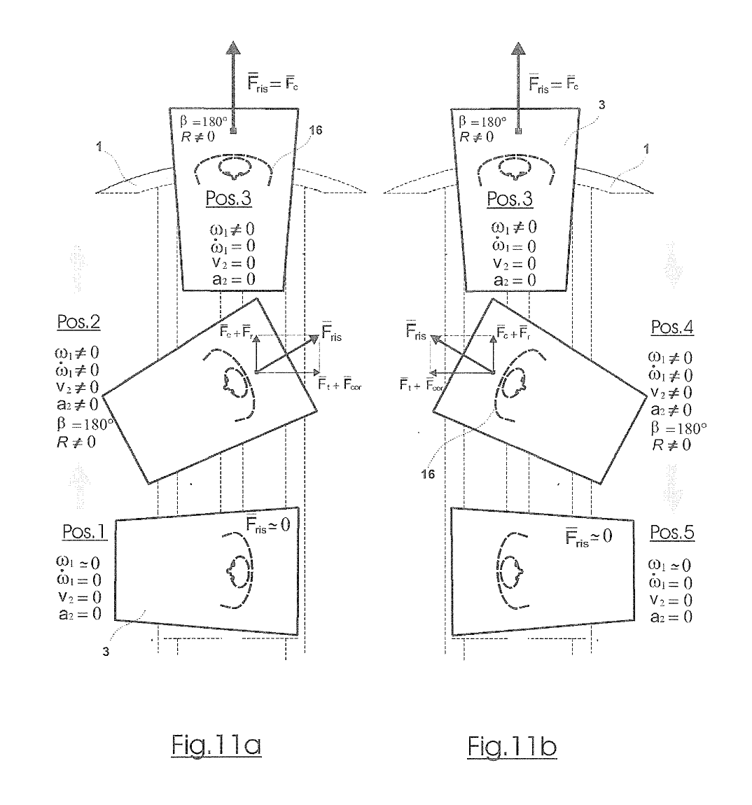

(FIG. 8) generated by the rotation of part 1 and the position of part 2 [91], and the following unwanted ‘parasitic forces’, RADIAL FORCE (FIG. 10a), TANGENTIAL FORCE (FIG. 10b) and FORCE OF CORIOLIS (FIG. 10c).

The radial force

Fᵣ=mₛ·a₂,

is present during the acceleration of part 2

a₂=0

(FIG. 10a).

The tangential force

### Fₜ,

is present during the accelerated rotation of part Land with a distance R of part 2 different from zero (FIG. 10b).

The Coriolis force

F_{cor}=2·mₛ·ω₁·v₂,

is created when part 1 is rotating,

ω₁=0,

and part 2 is moving

v₂=0

(FIG. 10c).

It is interesting to note that the parasitic forces

### Fₜ

and

### F_{cor}

[114] [115] created for

ω≠0,

are present only if there is a centrifugal force

### F_{C}.

The forces

### Fᵣ,

### Fₜ

and

### F_{cor}

are considered parasitic forces because they create a distortion of the angle

β

during the dynamic working of the Simulator. The aspect which creates problems is the direction of these forces, while their absolute value can be exploited advantageously to further reduce the transitional time shifting from one state to another.

A driving scenario on a road journey of a real vehicle can be represented, as a series of straight sections joined together by curves. A typical realistic scenario is as follows: the vehicle starts from stationing and accelerates up to reach a constant speed, then when it reaches a bend, brakes, along the curve, accelerates and reaches a constant speed and, finally, after running along several straights and curves, it slows and stops. This real scenario can further be represented through a sequence of successive states under a working system [106], [107], [108]: A) vehicle stopped->B) acceleration->C) constant speed->D) braking (deceleration)->E) bend->B) acceleration->C) constant speed->D)braking->A) vehicle stationing.

Let us see now how the simulator is able to simulate changes of state indicated in [119].

Analyzing the dynamic sequences in pairs, the first change of status is A->B from STATIONARY VEHICLE to CONSTANT SPEED to ACCELERATION. Status A is obtained by the simulator for

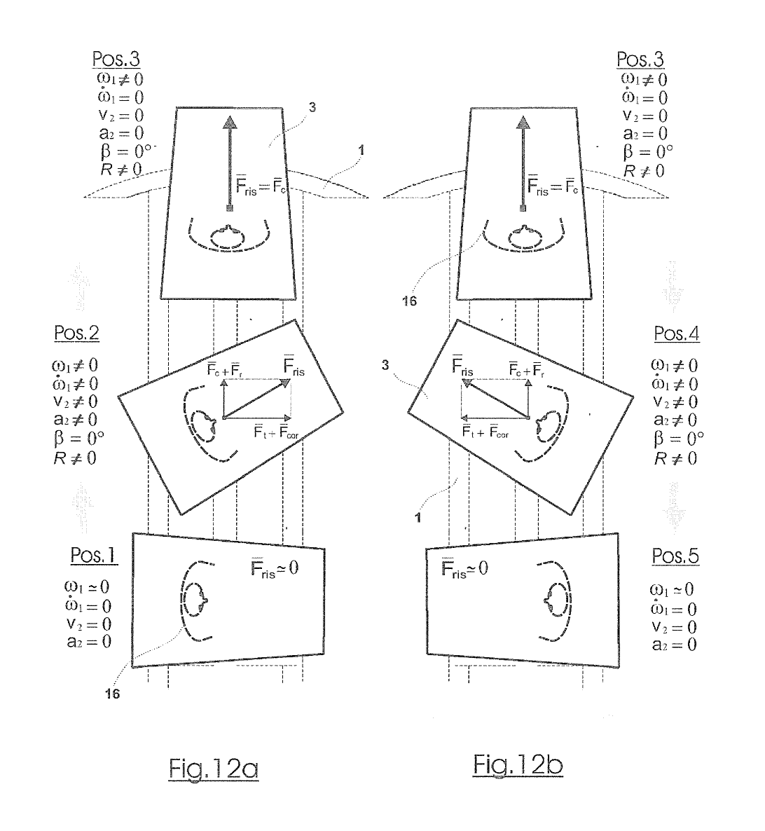

ω₁
≠0,
vₐ
=0 (Pos-1 FIG. 11-a), and through intermediate steps (see Pos-2 FIG. 11-a) we arrive at B for
ω₁
≠0
v₂
=0 (Pos-3—FIG. 11a). Returning as described in [113] [118] and in reference to FIG. 11a, you can see how the transition from Pos-1(
ω₁≅
0,
v₂
=0), through the Pos-2 (which is the accelerated rotation of part 1
≠0,
a₁≠
0, with the movement of part 3

### 0), up to the Pos-3 (

ω₁
≠0,
a₁=
0,
v₂
=0) produces parasitic forces that are compensated by the Simulator to maintain the same sensation of a uniform increase of acceleration. The transition from
ω₁
=0 to
ω₁
≠0 creates the tangential force

### Fₜ;

the change in speed
v₂
creates the radial force

### Fᵣ,

and the simultaneous presence of
ω₁
≠0 and
v₂≠
0 creates the coriolis force

### F_{cor}.

These three additional unwanted forces

### Fₜ,

### Fᵣ,

### F_{cor},

in addition to the centrifugal force

### F_{C},

create the resultant force

### F_{RIS},

and are produced by the dynamic of the Simulator which are compensated by the instantaneous position of part 3 by varying the angle
α
(see FIG. 11a). The driver in fact, during the transition from Pos-1 to Pos-3 has always a uniform sensation of an increase of acceleration without any element of distortion (see zone (1) FIG. 14a) As you can see the angle
β
remains constant to 180°.

The second change of state [119] is B->C, from ACCELERATION to CONSTANT SPEED. The situation is functionally the opposite of the previous case [121]. We have the transition

ω₁
≠0,
a₁=
0,
v₂≠

0 (Pos-3 FIG. 11b) through

ω₁
≠0,
a₁≠
0,
v₂≠
0 (radial movement toward the centre of part 3 and the slowing of rotation of part 1, Pos-4 FIG. 11b), up to
ω₁≈
0,
v₂=
0 (Pos-5 FIG. 11-b). As can be seen from FIG. 11b, in transition from the start position to finish (Pos-4), the position of the angle
α
changes its value to compensate for the presence of transitional forces

### Fₜ,

### Fᵣ,

### F_{cor},

and to maintain the angle constant
β
at 180°. In this way the driver does not perceive any distortion during the decrease of acceleration (zone (2) FIG. 14a).

As can be seen from previous points [121] and [122], part 3 has an extended function inside the Simulator. It allows the simulation of the vehicle on a bend, as well as to compensate, changing the angle

α,

at any time, the distorting effect of unwanted parasitic forces (created during the dynamic working of Simulator) maintaining the angle

β

fixed to the desired value.

Similarly to [121] and [122], we can analyze other changes of status which were due to the [119]; even in these cases parasitic forces emerge as described in [113].

The change in status [119] C->D from CONSTANT SPEED to BRAKING is represented in FIG. 12a. As can be seen, thanks to the compensation effect of part 3 (Pos-2 FIG. 12-a) the angle

β
remains constant at 0°, and the user perceives a uniform increase of braking (deceleration) (zone (1) FIG. 14b)

The change in status [119]D->A from BRAKING to STATIONARY VEHICLE/CONSTANT SPEED, is represented in FIG. 12b. The angle

β

remains constant at 0° and the driver feel a decrease in braking without distortions (zone (2) FIG. 14b).

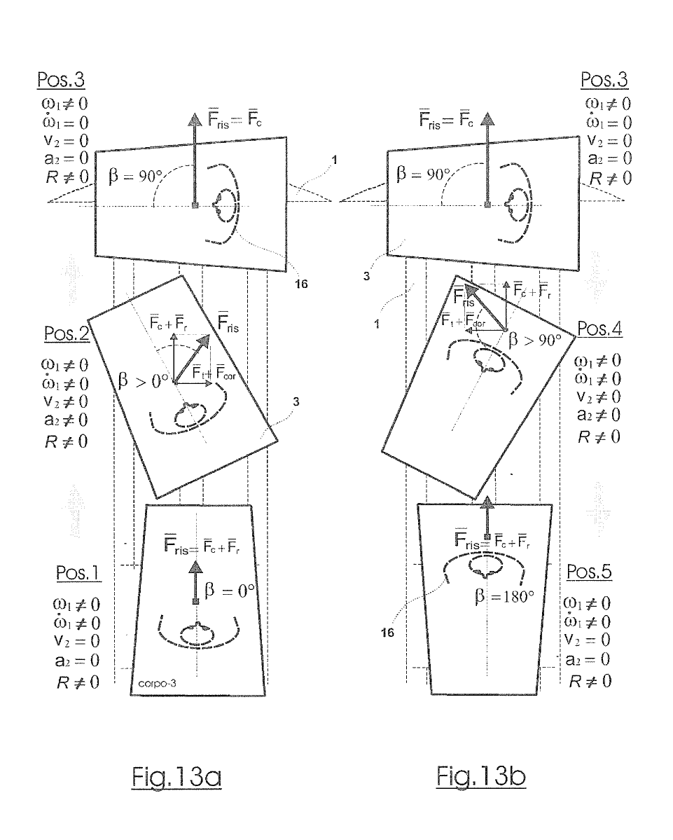

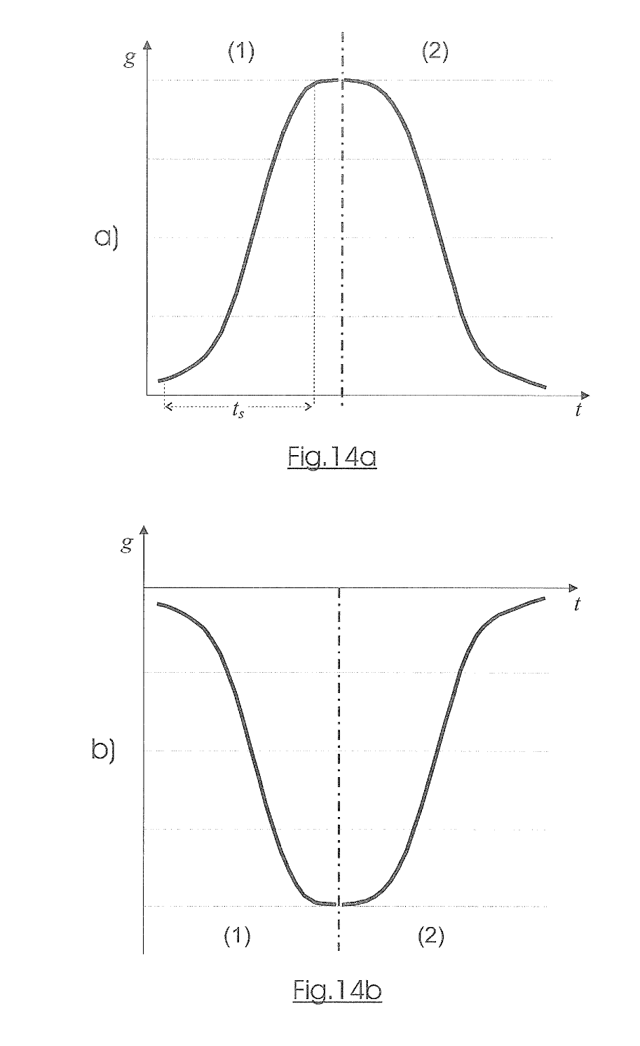

The change in status D->E from BRAKING to CURVE, is expressed by FIG. 13a (the example shown is a curve to the left, but nothing would be changed for a curve to the right). The transition from a straight manoeuvre on a curve is gradually created by the Simulator varying the angle

β

from 0° to 90°. Through adjusting the position of the angle

α

of part 3, it is possible to compensate the distortive effect of parasitic forces and, simultaneously, to follow the predetermined angle

β.

As for the change of status E->B from CURVE to ACCELERATION this is expressed by FIG. 13b. We can do the same considerations of the previous case [127]. In this case there is the transition of angle

β

from 90° to 0°.

We analyzed by means of FIG. 11, FIG. 12 and FIG. 13, the dynamic changes of state as described in [119]. There are theoretically possible other status changes such as CONSTANT SPEED->CURVE; CURVE->CONSTANT SPEED/STATIONARY VEHICLE; ACCELERATION->CURVE, etc. These changes are not represented graphically as they can be easily referred to the previously analyzed cases.

In [119], we analyzed the changes of status in pairs for a clearer description. In a real situation, however, the changes should be analyzed in groups of three. In fact, a real vehicle starts from a static situation (stationary vehicle or fixed/constant speed), it accelerates, brakes, or takes a bend, and finally back to a stationary position. So, in relation to [119], the sequences of a change of status should be analyzed as: A->B->C, C->D->A and C->D->E->B->C. In FIGS. 11, 12, 13 the status changes are represented respectively as A->B->C, C->D->A and D->E->B (in the latter case the shift from state C and towards C is irrelevant), which are same as above. It is essential at this point to highlight how the passages of state expressed in FIG. 11, FIG. 12 and FIG. 13 demonstrate the achievement of an important goal of the Simulator, namely to make a faithful simulation of seamless continuity. The only clarification to be added concerning the different starting position Pos-1 and final Pos-5 of part 3 in FIG. 11 and FIG. 12 which refer to the same state do not seem to allow a simulation of seamless continuity. Firstly, it must be pointed out that it is not necessary for Pos-1 and Pos-5 to be different, in fact, they may be the same with angle

α
=0° o 180°. But since the working of the Simulator may develop symmetrically on both sides of part 1 (see FIG. 9), the Pos-5 of FIG. 11 or FIG. 12, is respectively equivalent to Pos-1 of the same figures viewed symmetrically compared to part 1. It is to be noted also that Pos-5 of FIG. 11 is equal to Pos-1 of FIG. 12 and vice versa, and this follows the normal functioning of a real vehicle that after a phase of acceleration has a phase of braking normally, and after a phase of braking, an acceleration phase. However, as mentioned previously, Pos-1 and Pos-5 of FIG. 11 and FIG. 12 may be perfectly identical, thus making one part of the part 1 of the Simulator work.

The Simulator comprises not only the mechanical structure described above, but also includes an electrical mechanism.

The electrical part consists of the following main elements: computers, controllers/regulators, sensors, displays and additional equipment.

Sensors allow the measurement of the physical quantities necessary to control the Simulator.

In part 1 we have sensors of position and of angular velocity to measure directly or indirectly

ω₁
and
a₁.

In the part 2 there are sensors of position and of linear acceleration to measure

v₂

and

a₂.

On part 3 we have sensors of position and angular acceleration to measure

α
and F̅ᵣᵢₛ.

Computers and controllers are located: one on part 1, one on part 2 and one on part 3. The computer positioned in part 3 is the main one and serves as a supervisor for the other controllers, and it is that which makes implementations of control of mechanical structure in function of simulation software displayed. It is the device that combines simulation of the physical forces with the simulation of the software.

If the Simulator is a ‘passive’ type in which the user has the function of spectator of simulation (Ex. For a playground), or ‘active’ type, in which the user is the active driver of the vehicle simulated (Ex. videogames, driving simulator), additional equipment such as a steering wheel, brake, accelerator, gear, etc. will be present in part 3.

It is important, finally, to point out that, even if in describing we have always mentioned a single user, part 3 may contain more than one user especially regarding the ‘passive’ type of Simulators. This type of simulators is suitable for use at fairs and amusement arcade.

1. The invention consists of a Simulator comprising three moving parts which are joined and work together.
The first part has a circular motion with respect to its vertical axis of rotation and is supported by a fixed base, the second part, integral to the first part has a longitudinal movement (horizontal) perpendicular to the rotation axis of the first part. The third part, integral to the second part, acts as placement for the user who is the subject of the simulation's effects. The third part has a circular motion with respect to its vertical axis of rotation which is parallel to the axis of rotation of the first part.
The longitudinal movement of the second part, in synergy with the rotation of the first part and the instantaneous angular placement of the third part, makes it possible to represent a continuous development of any acceleration, deceleration of braking and lateral force of any dynamic situation in vehicle movement.
This produces a faithful simulation for any development in time of force which subjects the user (who is positioned in the third part) to the generation of strong forces at short intervals of time and seamless continuity.

2. As claimed in claim [1], the first part has a circular motion with constant direction of rotation and generates a centrifugal force variable as a function of its angular velocity.

3. As claimed in claim [1], the first part has shock absorbers at its ends that are used to compensate the centrifugal force produced by the rotation of the first part, which involves both the second and the third parts.

4. As claimed in claim [1], the second part, integral to the first part, has a longitudinal movement perpendicular to the axis of vertical rotation of the first part, which has the effect of reducing the total inertia moment of the Simulator, decreasing the distance of its Barycentre from the axis of rotation of the first part.

5. The second part, as claimed in claim [4] and [1], reduces the time of transition (the rise time) so creating a particular simulated force upon the user (who is the subject of the simulation's effects), and, similarly, allowing the generation of a strong force in a short rise time.

6. As claimed in claim [1], the second part changes the value of the centrifugal force produced by the first part, by varying the distance between the Barycentre of the user and the axis of rotation of the first part.

7. As claimed in claim [1], the second part, thanks to its movement throughout the diameter of the first part, is able to reverse the force which subjects the user to the effect of being thrown from one side to the other while staying positioned in the third part.

8. As claimed in claim [1], the third part has a circular motion with respect to its vertical axis and varies its angle position depending on the rotation of the first part and the position of the second part, to simulate the forces on the user (acceleration, deceleration (braking) and lateral thrust on a bend).

9. As claimed in claims [8] and [1] the third part, varies instantaneously its position angle to compensate for the additional forces produced by the variation of the angular speed of the first part and/or the variation of linear speed of the second part to maintain constantly the feeling of simulation you want to get (acceleration, braking, cornering and lateral thrust).

10. As claimed in claims [9], [8] and [1], the Simulator produces a uniform increase of acceleration for the user thanks to
the initial positioning of the second part close to the rotation axis of the first part and/or low angular rotational frequency of the first part,
the subsequent increase of rotational speed of the first part with the consequent moving out towards the side of the second part up to stopping in a preset position;
simultaneously, the third part changes its angular position at any moment in order to maintain the integral direction of placement of the user in respect to generated forces, so as to keep a sense of uniform acceleration. (see FIG. 11a)

11. As claimed in claims [9], [8] and [1], the Simulator produces a uniform decrease of acceleration on the user, through the initial positioning of the second part to a certain distance from the axis of rotation of the first part which presents angular speeds different from zero, and through the subsequent decrease in speed of rotation of the first part with the consequent movement towards the inside of the second part up to stopping in a preset position close to the rotation axis of the first part (and/or with low angular speed of the first part). Simultaneously, the third part changes its angular position at any moment in order to maintain the integral direction of the positioning of the user, to the forces generated, so as to produce a uniform feeling of a decrease in acceleration. (see FIG. 11b)

12. As claimed in claims [9], [8] and [1], the Simulator produces a uniform increase of deceleration (braking) on the user thanks to:
the initial positioning of the second part close to the rotation axis of the first part (and/or low angular speed of the first part), and the subsequent increase in the rotational speed of the first part with the consequent moving out towards the side of the second part up to stopping in a preset position;
simultaneously, the third part changes its angular position at any moment to maintain the integral positioning of the user to the forces generated from the Simulator, so as to produce a uniform feeling of deceleration. (see FIG. 12a)

13. As claimed in claims [9], [8] and [1], the Simulator produces a uniform decrease in deceleration (braking) on the user, through the initial positioning of the second part to a certain distance from the rotational axis of the first part with an angular speed different from zero, and through the subsequent decrease of rotational speed of the first part with the consequent movement towards the inside of the second part up to stopping in a preset position near to the rotational axis of the first part (and/or with angular speed of the first part almost at zero). Simultaneously, the third part changes its angular position at any moment to maintain the integral positioning of the user compared to the forces generated, in order to produce a uniform sensation of a decrease in deceleration. (see FIG. 12b)

14. As claimed in claims [9], [8] and [1], the Simulator produces a uniform increase of lateral thrust on the user by the rotation of the first part and the movement of the second part outwards. Simultaneously, the third part changes its angular position at any moment, in order to maintain the integral force resulting on the placement of the user in order to obtain the desired sensation of a uniform increase in lateral thrust. (see FIG. 13a)

15. As claimed in claims [9], [8] and [1], the Simulator produces a uniform decrease of lateral thrust on the user by reducing angular speed of the first part and the second part moving inwards. Simultaneously, the third part changes its angular position at any moment, in order to maintain the integral force resulting on the placement of the user in order to obtain the desired sensation of a uniform decrease in lateral thrust. (see FIG. 13b)
